(19) United States
(12) Patent Application Publication
(10) Pub. No.: US 2018/0166073 A1
(43) Pub. Date: Jun. 14, 2018

(54) Speech Recognition Without Interrupting The Playback Audio

(71) Applicant: Ford Global Technologies, LLC, Dearborn, MI (US)

(72) Inventor: Sandeep Raj Gandiga, Sunnyvale, CA (US)

(21) Appl. No.: 15/377,600

(22) Filed: Dec. 13, 2016

(51) Int. Cl. G10L 15/22; G10L 21/028

(52) U.S. Cl. CPC G10L 15/22; G10L 2015/223; G10L 21/028

(57) ABSTRACT

Systems, methods, and devices for capturing speech input from a user are disclosed herein. A system includes a playback audio component, an audio rendering component, a capture component, a filter component, and a speech recognition component. The playback audio component is configured to buffer audio data for sound generation. The audio rendering component is configured to play the audio data on one or more speakers. The capture component is configured to capture audio (captured audio) using a microphone. The filter component is configured to filter the captured audio to generate filtered audio, wherein filtering includes filtering using the buffered audio data to remove audio corresponding to the audio data from the captured audio. The speech recognition component is configured to generate text or commands based on the filtered audio.

### TECHNICAL FIELD

The disclosure relates generally to methods, systems, and apparatuses for speech recognition and more particularly relates to speech recognition without interrupting playback audio.

### BACKGROUND

Voice recognition allows voice commands spoken by a user to be interpreted by a computing system or other electronic device. For example, voice commands may be recognized and interpreted by a mobile phone, mobile computing device, in-dash computing system of a vehicle, or the like. Based on the voice commands, a system may perform or an initiate an instruction or process.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating a speech recognition system, according to one implementation;

FIG. 2 is a schematic diagram illustrating speech recognition during audio playback, according to one implementation;

FIG. 3 is a schematic block diagram illustrating example components of a text-to-speech component, according to one implementation;

FIG. 4 is a schematic flow chart diagram illustrating a method for capturing speech input from a user, according to one implementation; and

FIG. 5 is a schematic block diagram illustrating a computing system, according to one implementation.

### DETAILED DESCRIPTION

Some speech recognition systems, such as-in vehicle infotainment systems, smart phones, or the like, are also capable of playing music and sounds. The sounds may include alerts, chimes, voice instructions, sound accompanying a video or graphical display, or the like. However, these systems stop music or sound playback when a voice recognition session is activated. During the break in music or sound, the system may capture the voice data/command from the user and may resume the playback. After capturing the voice data, the system may proceed to process the voice data and understand what has been said (e.g. speech-to-text or speech/voice recognition).

Applicants have developed systems, methods, and devices for capturing speech input from a user where there is no need to stop, pause, delay, or interrupt the sound playback in order to record/obtain the voice data. According to one embodiment, a system includes a playback audio component, an audio rendering component, a capture component, a filter component, and a speech recognition component. The playback audio component is configured to buffer audio data for sound generation. The audio rendering component is configured to play the audio data on one or more speakers. The capture component is configured to capture audio (captured audio) using a microphone. The filter component is configured to filter the captured audio to generate filtered audio, wherein filtering includes filtering using the buffered audio data to remove audio corresponding to the audio data from the captured audio. The speech recognition component is configured to generate text or commands based on the filtered audio.

According to one embodiment, when music or sound playback is on and a user chooses to activate speech recognition, the system lets playback continue and activates a voice session. During the voice session, a microphone may capture voice data plus the playback audio coming through the speakers (microphone captured voice sample). The microphone will capture voice, ambient sounds, and/or audio played by the speakers. The system can internally capture the playback audio data (e.g. decoded raw audio buffers) that is played through the speakers. Thus, there is no need for any external/secondary microphone to capture playback from speakers. The microphone captured voice sample and playback audio data may be fed into audio filters (or acoustics module). An audio filter may filter/phase out the playback audio from the microphone captured voice sample, which results in only the voice data (or the ambient sound minus the playback audio played on the speaker). This filtered voice data can be used further to understand what the user said. In one embodiment, the methods indicated herein may be performed using software and thus may be implemented in existing devices using a software update.

Further embodiments and examples will be discussed in relation to the figures below.

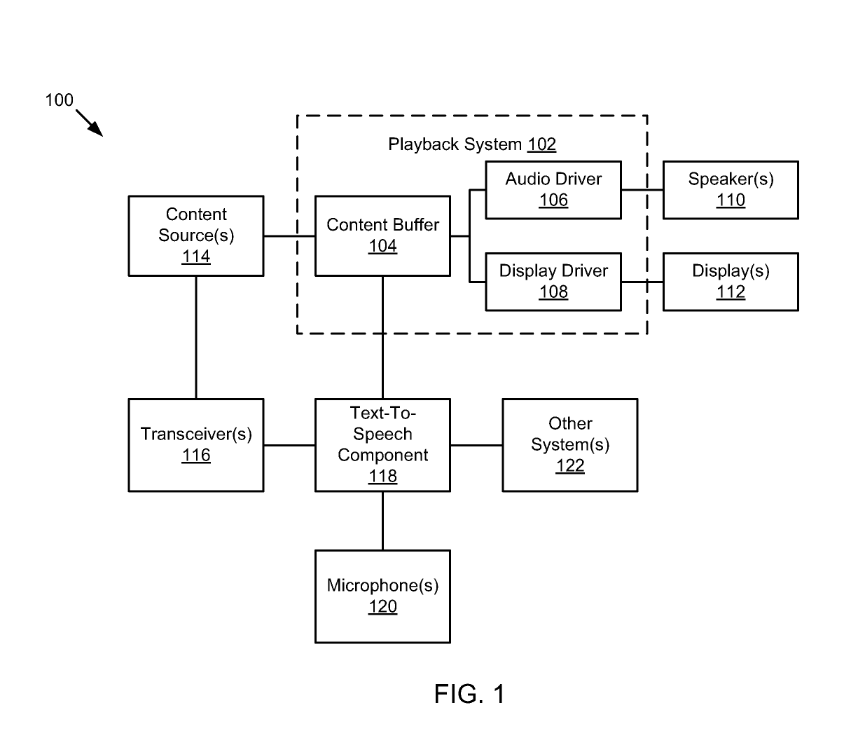

FIG. 1 is a schematic block diagram illustrating a speech recognition system 100. The system 100 includes a playback system 102 for playing media content. The playback system 102 may include a content buffer 104 that buffers content to be played or rendered by an audio driver 106 or display driver 108 on speakers 110 and/or a display 112. The content buffer 104 may include memory or register that holds content that will be provided to drivers 106, 108 for rendering/playback. The content buffer 104 may receive content from one or more content sources 114. The content sources 114 may include storage media or retrieve content from storage media to be played by the playback system 102. The content sources 114 may obtain content from any source or storage media. For example, the content sources 114 may include a magnetic, solid state, tape, optical (CD, DVD), or other drive. The content sources 114 may include a port for providing media content to the playback system 102. The content sources 114 may obtain media from a remote location, such as via a transceiver 116.

The speech recognition system 100 also includes a text-to-speech component 118 that receives captured audio from a microphone 120 and, based on the captured audio, recognizes voice or audio commands. In one embodiment, the text-to-speech component 118 obtains buffered audio from the content buffer 104 and filters the captured audio based on the buffered audio. For example, the microphone 120 may capture audio that includes audio content played by or on the speakers 110. Because the text-to-speech component 118 may have the buffered audio that corresponds to playback audio played by the speakers 110, the text-to-speech component 118 may filter out the playback audio to leave voice commands or voice input more clearly decipherable for text-to-speech or speech recognition.

The text-to-speech component 118 may perform text-to-speech or recognize voice commands and output the text-or-voice commands to other parts of the speech recognition system 100 as needed. For example, the text-to-speech component 118 may provide playback instructions to the playback system 102, or may provide other type of instructions to one or more other systems 122. The other systems 122 may include control systems for the speech recognition system 100, a vehicle, a computing device, mobile phone, or any other device or system. Example instructions or text may include instructions and text that initiate a phone call, stop or start playback, initiate or end navigation, or the like. In one embodiment, the text or instructions may control an in-dash system of a vehicle and any computing system or components of the vehicle.

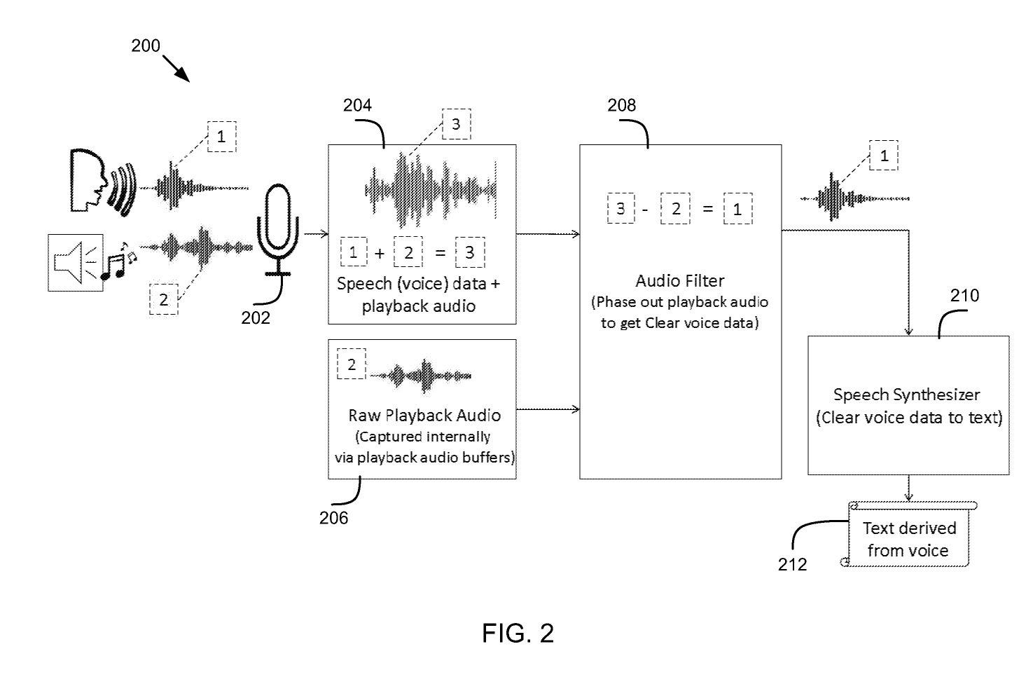

FIG. 2 is a schematic diagram illustrating a process 200 for speech recognition in the presence of playback audio. The process 200 may allow for speech recognition to be performed without pausing, stopping, delaying, or interrupting playback of audio (music, notification or other sound). A microphone 202 may capture and/or store audio at 204. The audio may include voice audio 1 spoken by a user and playback audio 2 played by a speaker. It should be noted that the playback audio 2 may include any audio such as music, notification sounds, voice instructions (such as for notification) or any other audio or sound played on a speaker. Because both the playback audio 2 and the voice audio 1 are present, the captured audio 3 includes a combination of both the playback audio 2 and the voice audio 1. The playback audio 2 is obtained at 206. The playback audio 2 may be obtained by retrieving audio data from a buffer for a device driving a speaker playing the playback audio 2.

At 208, the playback audio 2 is removed from the captured audio 3 using an audio filter. The audio filter may phase out the playback audio 2 to get clear voice audio 1 data as spoken by a user. For example, because both the playback audio 2 and captured audio 3 are known, the filter can obtain the voice audio 1. The voice audio 1 is provided to a speech synthesizer at 210 for speech recognition. The speech synthesizer can more accurately and easily convert the voice audio 1 to text or voice commands because it is unobstructed/unobscured by the playback audio 2. The speech synthesizer may output text or other commands derived from the voice data 1 at 212. Thus, speech recognition may be performed with good performance without pausing or otherwise altering playback audio 2.

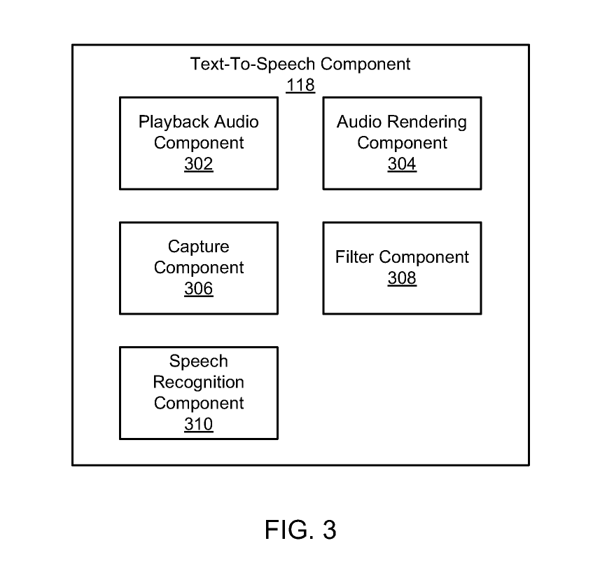

Turning to FIG. 3, a schematic block diagram illustrating components of a text-to-speech component 118, according to one embodiment, is shown. The text-to-speech component 118 may provide speech recognition or text-to-speech of voice audio even in a noisy environment, according to any of the embodiments or functionality discussed herein. The text-to-speech component 118 includes a playback audio component 302, an audio rendering component 304, a capture component 306, a filter component 308, and a speech recognition component 310. The components 302-310 are given by way of illustration only and may not all be included in all embodiments. In fact, some embodiments may include only one or any combination of two or more of the components 302-310. For example, some of the components 302-310 may be located outside or separate from the text-to-speech component 118.

The playback audio component 302 is configured to buffer audio data for sound generation. For example, the playback audio component 302 may include a content buffer 104 or may retrieve data from a content buffer 104. The buffered audio may be stored so that audio data that has been (or will be) played on one or more speakers over a time period is available for filtering. In one embodiment, the playback audio component 302 is configured to determine whether any audio data is being played. For example, if no audio is being played, then there may be no need to buffer audio data. Similarly, the playback audio component 302 may determine whether speech recognition is being performed or requested. For example, the playback audio component 302 may maintain at least a predetermined amount of audio buffer when there is no playback, but then gather all audio buffered during a speech recognition time period. Thus, the playback audio component 302 may have at least enough buffered audio data to remove corresponding audio played on a speaker from microphone captured data. In one embodiment, the playback audio component 302 buffers the audio data in response to determining that audio data is being played and/or that speech recognition is active. The playback audio component 302 may determine a timing for the playing of the audio data. The timing information may allow for targeted filtering so that the corresponding sounds can be removed from the correct time periods of microphone captured data.

The audio rendering component 304 is configured to play the audio data on one or more speakers. The audio rendering component 304 may include an audio driver 106 (such as a software driver and/or a hardware amplifier or sound card) for providing electrical signals to a speaker for playback. The audio rendering component 304 may obtain audio data from a content buffer 104 and convert raw audio data into analog signals for driving a speaker.

The capture component 306 is configured to capture audio using a microphone. The capture component 306 may capture audio during a speech recognition time period. The speech recognition time period may begin in response to receiving an indication that a user has requested speech recognition by the speech recognition component 310. A user may initiate speech recognition, for example, by selecting an on screen or button option to initiate speech recognition or by speaking a trigger word or phrase. The trigger word or phrase may include a special word or phrase that a device listens for and only begins speech recognition if that word or phrase is detected.

In one embodiment, the capture component 306 is configured to capture the captured audio during the playing of the audio data on the one or more speakers. For example, the capture component 306 may capture both voice audio spoken by a user as well as playback audio played by a speaker.

The filter component 308 is configured to filter the captured audio from a microphone to generate filtered audio. The filter component 308 may use the buffered playback audio obtained by the playback audio component 302 to remove any sounds that were played on a speaker. For example, the filter component 308 may filter the playback audio out of the captured audio so that the resulting filtered audio does not include, or includes a muted or less prominent version of, the playback audio. The filter component 308 may use the raw audio data and/or any timing information to remove playback audio corresponding to the raw audio.

Applicants have recognized that since the audio data that will be played is known (and may be determined by software buffering raw audio data to be played) the filter component 308 can very accurately and efficiently remove corresponding audio data from the captured audio. Although speakers may not playback the audio with 100% fidelity and the microphone may not capture the playback audio with 100% fidelity, filtering using the raw audio data can provide significant improvement in reducing or removing the playback audio from the microphone recording. In fact, the removal of the playback audio may be achieved sufficiently so that only a single microphone is required. Thus, the filter component 308 may not require special hardware configurations (e.g., two microphones) in order to accurately remove playback audio. After filtering, voice data, if any, captured by the microphone may be more prominent and easy to detect and decipher than if the playback audio were still present.

The speech recognition component 310 is configured to perform speech recognition on the filtered audio provided by the filter component 308. The speech recognition component 310 may generate text or commands based on the filtered audio. For example, the speech recognition component 310 my identify sounds or audio patterns that correspond to specific words or commands. In one embodiment, the speech recognition component 310 is further configured to determine an action to be performed by a computing device or control system based on the text or command. For example, the speech recognition may determine that a user is instructing a system or device to perform a process or initiate an action.

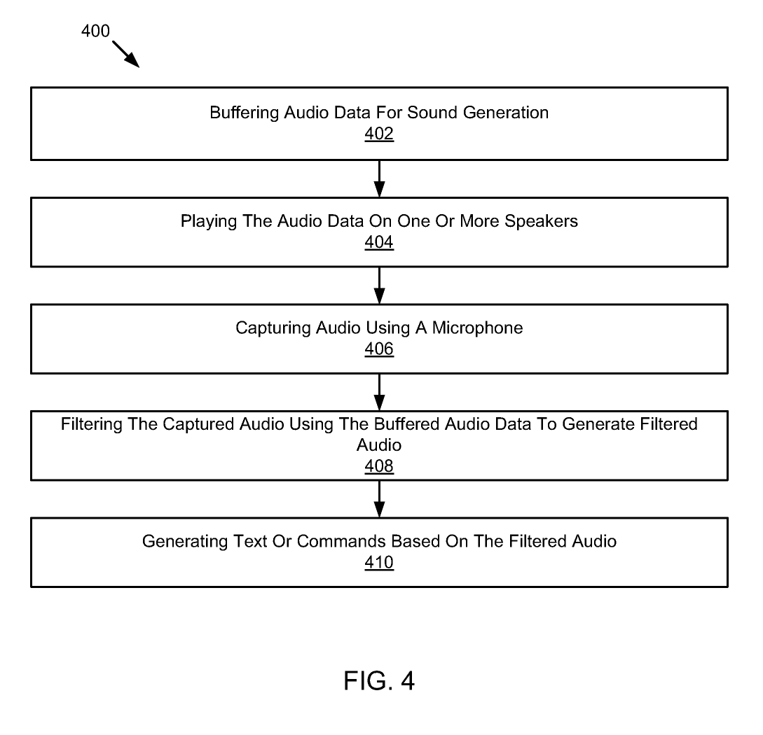

FIG. 4 is a schematic flow chart diagram illustrating a method 400 for capturing speech input from a user. The method 400 may be performed by a speech recognition system or a text-to-speech component, such as the speech recognition system 100 of FIG. 1 or the text-to-speech component 118 of FIG. 1 or 3.

The method begins and a playback audio component 302 buffers at 402 audio data for sound generation. The audio rendering component 304 plays at 404 the audio data on one or more speakers. The capture component 306 captures at 406 audio (captured audio) using a microphone. The filter component 308 filters at 408 the captured audio to generate filtered audio. The filter component 308 may filter using the buffered audio data to remove audio corresponding to the audio data from the captured audio. The speech recognition component 310 generates at 410 text or commands based on the filtered audio.

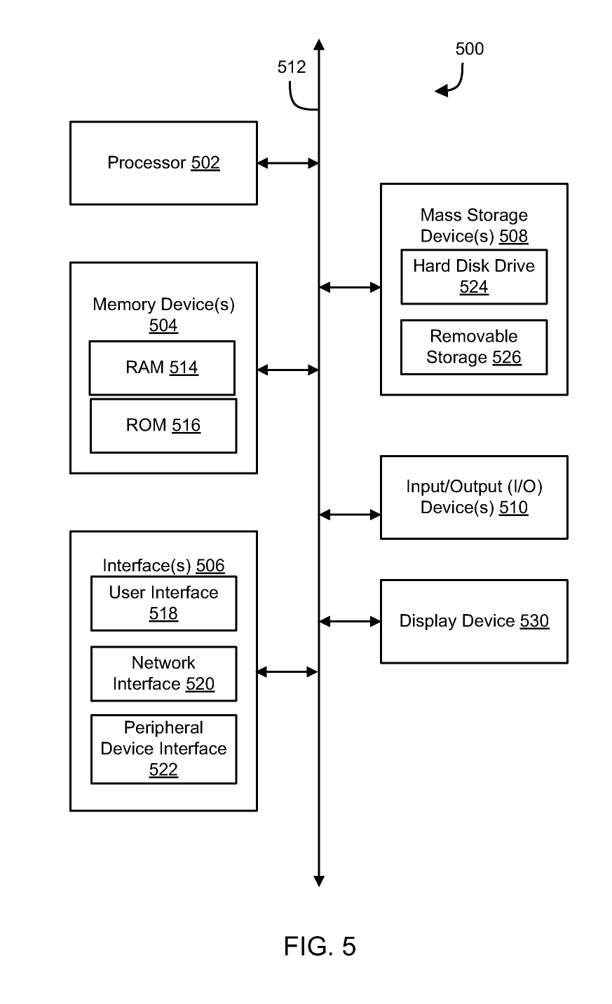

Referring now to FIG. 5, a block diagram of an example computing device 500 is illustrated. Computing device 500 may be used to perform various procedures, such as those discussed herein. Computing device 500 can function as a speech recognition system 100, text-to-speech component 118, or the like. Computing device 500 can perform various functions as discussed herein, such as audio capture, buffering, filtering, and processing functionality described herein. Computing device 500 can be any of a wide variety of computing devices, such as a desktop computer, in-dash vehicle computer, vehicle control system, a notebook computer, a server computer, a handheld computer, tablet computer and the like.

Computing device 500 includes one or more processor(s) 502, one or more memory device(s) 504, one or more interface(s) 506, one or more mass storage device(s) 508, one or more Input/Output (I/O) device(s) 510, and a display device 530 all of which are coupled to a bus 512. Processor(s) 502 include one or more processors or controllers that execute instructions stored in memory device(s) 504 and/or mass storage device(s) 508. Processor(s) 502 may also include various types of computer-readable media, such as cache memory.

Memory device(s) 504 include various computer-readable media, such as volatile memory (e.g., random access memory (RAM) 514) and/or nonvolatile memory (e.g., read-only memory (ROM) 516). Memory device(s) 504 may also include rewritable ROM, such as Flash memory.

Mass storage device(s) 508 include various computer readable media, such as magnetic tapes, magnetic disks, optical disks, solid-state memory (e.g., Flash memory), and so forth. As shown in FIG. 5, a particular mass storage device is a hard disk drive 524. Various drives may also be included in mass storage device(s) 508 to enable reading from and/or writing to the various computer readable media. Mass storage device(s) 508 include removable media 526 and/or non-removable media.

I/O device(s) 510 include various devices that allow data and/or other information to be input to or retrieved from computing device 500. Example I/O device(s) 510 include cursor control devices, keyboards, keypads, microphones, monitors or other display devices, speakers, printers, network interface cards, modems, and the like.

Display device 530 includes any type of device capable of displaying information to one or more users of computing device 500. Examples of display device 530 include a monitor, display terminal, video projection device, and the like.

Interface(s) 506 include various interfaces that allow computing device 500 to interact with other systems, devices, or computing environments. Example interface(s) 506 may include any number of different network interfaces 520, such as interfaces to local area networks (LANs), wide area networks (WANs), wireless networks, and the Internet. Other interface(s) include user interface 518 and peripheral device interface 522. The interface(s) 506 may also include one or more user interface elements 518. The interface(s) 506 may also include one or more peripheral interfaces such as interfaces for printers, pointing devices (mice, track pad, or any suitable user interface now known to those of ordinary skill in the field, or later discovered), keyboards, and the like.

Bus 512 allows processor(s) 502, memory device(s) 504, interface(s) 506, mass storage device(s) 508, and I/O device(s) 510 to communicate with one another, as well as other devices or components coupled to bus 512. Bus 512 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to further embodiments.

Example 1 is a method for capturing speech input from a user. The method includes buffering audio data for sound generation. The method includes playing the audio data on one or more speakers. The method includes capturing audio (captured audio) using a microphone. The method includes filtering the captured audio to generate filtered audio, wherein filtering includes filtering using the buffered audio data to remove audio corresponding to the audio data from the captured audio. The method includes generating text or commands based on the filtered audio.

In Example 2, capturing the captured audio as in Example 1 includes using the microphone includes capturing during the playing of the audio data on the one or more speakers.

In Example 3, a method as in any of Examples 1-2 further includes determining whether any audio data is being played, wherein buffering the audio data includes buffering in response to determining that audio data is being played.

In Example 4, a method as in any of Examples 1-3 further includes determining a timing for the playing of the audio data.

In Example 5, filtering the captured audio using the buffered audio data as in Example 4 includes filtering based on the timing for the playing of the audio data.

In Example 6, buffering the audio data for sound generation as in any of Examples 1-5 includes capturing the audio data from a raw audio buffer before removal from the raw audio buffer, wherein the audio data is placed in the raw audio buffer prior to playing on the one or more speakers.

In Example 7, the audio data as in any of Examples 1-6 includes music, audio corresponding to a video, a notification sound, and a voice instruction.

In Example 8, a method as in any of Examples 1-7 further includes determining an action to be performed by a computing device or controlled system based on the text or command.

In Example 9, a method as in any of Examples 1-8 further includes receiving an indication to activate speech recognition, wherein buffering the audio data, capturing audio, filtering captured audio, and performing speech to text conversion includes buffering, capturing, filtering, and performing in response to receiving the indication.

Example 10 is a system that includes a playback audio component, an audio rendering component, a capture component, a filter component, and a speech recognition component. The playback audio component is configured to buffer audio data for sound generation. The audio rendering component is configured to play the audio data on one or more speakers. The capture component is configured to capture audio (captured audio) using a microphone. The filter component is configured to filter the captured audio to generate filtered audio, wherein filtering includes filtering using the buffered audio data to remove audio corresponding to the audio data from the captured audio. The speech recognition component is configured to generate text or commands based on the filtered audio.

In Example 11, a capture component as in Example 10 is configured to capture the captured audio during the playing of the audio data on the one or more speakers.

In Example 12, a playback audio component as in any of Examples 10-11 is further configured to determine whether any audio data is being played, wherein the playback audio is configured to buffer the audio data in response to determining that audio data is being played.

In Example 13, a playback audio component as in any of Examples 10-12 is further configured to determine a timing for the playing of the audio data.

In Example 14, a filter component as in Example 13 is configured to filter the captured audio using the buffered audio data based on the timing for the playing of the audio data.

In Example 15, a speech recognition component as in any of Examples 10-14 is further configured to determine an action to be performed by a computing device or control system based on the text or command.

Example 16 is computer readable storage media storing instructions that, when executed by one or more processors, cause the one or more processors to buffer audio data for sound generation. The instructions cause the one or more processors to play the audio data on one or more speakers. The instructions cause the one or more processors to capture audio (captured audio) using a microphone. The instructions cause the one or more processors to filter the captured audio to generate filtered audio, wherein filtering includes filtering using the buffered audio data to remove audio corresponding to the audio data from the captured audio. The instructions cause the one or more processors to generate text or commands based on the filtered audio.

In Example 17, instructions as in Example 16 further cause the one or more processors to capture the captured audio during the playing of the audio data on the one or more speakers.

In Example 18, instructions as in any of Examples 16-17 further cause the one or more processors to determine a timing for the playing of the audio data.

In Example 19, instructions as in Example 18 further cause the one or more processors to filter the captured audio using the buffered audio data based on the timing for the playing of the audio data.

In Example 20, instructions as in any of Examples 16-19 further cause the one or more processors to determine an action to be performed by a computing device or control system based on the text or command.

Example 21 is a system or device that includes means for implementing a method or realizing a system or apparatus in any of Examples 1-20.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. The terms “modules” and “components” are used in the names of certain components to reflect their implementation independence in software, hardware, circuitry, sensors, and/or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for capturing speech input from a user, the method comprising:
buffering audio data for sound generation;
playing the audio data on one or more speakers;
capturing audio (captured audio) using a microphone;
filtering the captured audio to generate filtered audio, wherein filtering comprises filtering using the buffered audio data to remove audio corresponding to the audio data from the captured audio; and
generate text or commands based on the filtered audio.

2. The method of claim 1, wherein capturing the captured audio using the microphone comprises capturing during the playing of the audio data on the one or more speakers.

3. The method of claim 1, further comprising determining whether any audio data is being played, wherein buffering the audio data comprises buffering in response to determining that audio data is being played.

4. The method of claim 1, further comprising determining a timing for the playing of the audio data.

5. The method of claim 4, wherein filtering the captured audio using the buffered audio data comprises filtering based on the timing for the playing of the audio data.

6. The method of claim 1, wherein buffering the audio data for sound generation comprises capturing the audio data from a raw audio buffer before removal from the raw audio buffer, wherein the audio data is placed in the raw audio buffer prior to playing on the one or more speakers.

7. The method of claim 1, wherein the audio data comprises music, audio corresponding to a video, a notification sound, and a voice instruction.

8. The method of claim 1, further comprising determining an action to be performed by a computing device or controlled system based on the text or command.

9. The method of claim 1, further comprising receiving an indication to activate speech recognition, wherein buffering the audio data, capturing audio, filtering captured audio, and performing speech to text conversion comprises buffering, capturing, filtering, and performing in response to receiving the indication.

10. A system comprising:
a playback audio component configured to buffer audio data for sound generation;
an audio rendering component configured to play the audio data on one or more speakers;
a capture component configured to capture audio (captured audio) using a microphone;
a filter component configured to filter the captured audio to generate filtered audio, wherein filtering comprises filtering using the buffered audio data to remove audio corresponding to the audio data from the captured audio; and
a speech recognition component configured to generate text or commands based on the filtered audio.

11. The system of claim 10, wherein the capture component is configured to capture the captured audio during the playing of the audio data on the one or more speakers.

12. The system of claim 10, wherein the playback audio component is further configured to determine whether any audio data is being played, wherein the playback audio is configured to buffer the audio data in response to determining that audio data is being played.

13. The system of claim 10, wherein the playback audio component is further configured to determine a timing for the playing of the audio data.

14. The system of claim 13, wherein the filter component is configured to filter the captured audio using the buffered audio data based on the timing for the playing of the audio data.

15. The system of claim 10, wherein the speech recognition component is further configured to determine an action to be performed by a computing device or control system based on the text or command.

16. Computer readable storage media storing instructions that, when executed by one or more processors, cause the one or more processors to:
buffer audio data for sound generation;
play the audio data on one or more speakers;
capture audio (captured audio) using a microphone;
filter the captured audio to generate filtered audio, wherein filtering comprises filtering using the buffered audio data to remove audio corresponding to the audio data from the captured audio; and
generate text or commands based on the filtered audio.

17. The computer readable storage media of claim 16, wherein the instructions further cause the one or more processors to capture the captured audio during the playing of the audio data on the one or more speakers.

18. The computer readable storage media of claim 16, wherein the instructions further cause the one or more processors to determine a timing for the playing of the audio data.

19. The computer readable storage media of claim 18, wherein the instructions further cause the one or more processors to filter the captured audio using the buffered audio data based on the timing for the playing of the audio data.

20. The computer readable storage media of claim 16, wherein the instructions further cause the one or more processors to determine an action to be performed by a computing device or control system based on the text or command.
